(19) United States
(12) Patent Application Publication
(10) Pub. No.: US 2013/0042984 A1
(43) Pub. Date: Feb. 21, 2013

(54) Curtain Tape

(71) Applicant: David Croucher, Perth (AU)

(72) Inventor: David Croucher, Perth (AU)

(21) Appl. No.: 13/578,035

(22) PCT Filed: Feb. 11, 2011
(86) PCT No.: PCT/AU2011/000144

§ 371 Date: Oct. 26, 2012

(30) Foreign Application Priority Data
Feb. 11, 2010 (AU) 2010900549
Aug. 5, 2010 (AU) 2010903495

(51) Int. Cl. D03D 1/06; E05D 15/06; A47H 1/00

(52) U.S. Cl. 160/330; 139/387 A; 16/87 R; 24/115 R

(57) ABSTRACT

Various curtain systems and components are disclosed. In one form of the invention there is provided a curtain system (10) having a curtain tape (14). The curtain tape (14) comprises a body (40) having a first portion (42) for being fixed to a curtain. A plurality of carrier mounts (48) are provided for mounting a plurality of carriers (52). The carrier mounts (48) are spaced along the length of the body (40) at intervals less than 2 cm to allow for the curtain to be hung from the carrier mounts (48) in any one of a plurality different configurations where each configuration is associated with a different curtain width.

### FIELD OF THE INVENTION

The present invention relates to curtain systems.

### INCORPORATION BY REFERENCE

Priority is claimed from Australian Provisional Application 2010900549 filed 11 Feb. 2010 entitled ‘U-Pleat curtain heading’. Priority is also claimed from Australian Provisional Application 2010903495 filed 5 Aug. 2010 entitled ‘Curtain Systems’. All parts and elements of Australian Provisional Applications 2010900549 and 2010903495 are hereby fully incorporated by reference for all purposes.

### BACKGROUND To THE INVENTION

Various types of domestic curtain systems are presently available for domestic houses, domestic apartments and other domestic dwellings. Such systems include pinch pleat systems, inverted pleat systems, gathered tape systems, table top heading systems and cased heading systems. These systems are generally cost effective and are readily installed by one or two trained professionals.

In comparison to domestic systems, more commercial systems are also available. These systems are generally suited to high use environments and heavy curtains such as used in hotels, motels, restaurants, hospitals and so forth. Such commercial systems are generally not used in domestic applications for the reason that they are engineered for high use environments and are accordingly more expensive to manufacture, purchase and install.

It is against this background that the present invention has been developed. It is to be recognised that any material discussed in the present specification is intended to explain the context of the invention. It is not to be taken as an admission that any material formed part of the prior art base or relevant general knowledge in any particular country or region.

### SUMMARY OF THE INVENTION

According to a first aspect of preferred embodiments herein described there is provided a curtain tape comprising: a body having a first portion for being fixed to a curtain; and a plurality of carrier mounts for mounting a plurality of carriers; wherein the carrier mounts are spaced along the length of the body at intervals less than 2 cm to allow for the curtain to be hung from the carrier mounts in any one of a plurality different configurations, each configuration being associated with a different curtain width.

Preferably the body comprises elastically resilient material arranged to provide u-shaped folds in the curtain when the carriers mounts are brought together, with the carrier mounts comprising loop portions each adapted for receiving a hook shaped carrier.

Preferably the loop portions are formed by fixing a piece of material in positions along the body of the curtain tape.

Preferably the body of the curtain tape and the piece of material comprise weldable material, with the piece of material being fixed to the body of the curtain tape by welding the piece of material and body together at fixed locations spaced apart along the length of the body and the piece of material.

Preferably the body of the curtain tape is less than 50 mm in width and the piece of material is less than 20 cm in width.

Preferably the curtain tape is formed from elastically resilient nylon mesh material.

According to a second aspect of preferred embodiments herein described there is provided a runner for a curtain track including: a lower portion having a mount adapted to be mounted to one of several cord mounts spaced along a flexible runner cord in a manner such that, when mounted thereto, the runner is able to rotate relative to the flexible runner cord about the longitudinal axis of the runner; the runner having an upper portion sized to receive a curtain hook such that when attached to the flexible runner cord, the runner can be removed therefrom and be used in a conventional curtain track, the upper portion having a width less than 0.5 mm so as to be able to receive a conventional curtain hook.

Preferably the upper portion of the runner has a width less than 0.3 mm and is able to receive a conventional Rufflette R7 sized hook.

According to a third aspect of preferred embodiments herein described there is provided a runner system comprising: a flexible runner cord having a plurality of cord mounts spaced therealong; and a plurality of runners each having a lower portion with a mount adapted to couple to a respective one of the cord mounts of the flexible cord such that, when coupled, each runner can rotate relative to the flexible cord along the longitudinal axis of the runner, each runner having an upper portion sized to receive a curtain hook such that when attached to the flexible runner cord, the runner can be removed therefrom and be used in a conventional curtain track, the upper portion having a width less than 0.5 mm so as to be able to receive a conventional curtain hook.

According to a fourth aspect of preferred embodiments herein described there is provided a curtain overlap system for a curtain having repeating portions, the overlap system comprising: a first slide component having a first overlap arm; and a second slide component having a second overlap arm; wherein the slide components are adapted to present the overlap arms behind a midline of the curtain, rearwardly relative to the front face of the curtain track, such that it appears that the repeating portions of the curtain are joined at the overlap.

Preferably the first overlap arm can be switched with the second overlap arm to allow the direction of the overlap to be changed.

According to a fifth aspect of preferred embodiments herein described there is provided a curtain overlap system comprising: a curtain hanging from a curtain track, wherein at an overlap of the curtain, a first side of the curtain is attached to an first overlap arm of a first slide component and a second side of the curtain is attached to a second overlap arm of a second slide component, the overlap arms extending behind a midline of the curtain relative to the front face of the curtain track such when the overlap arms are brought together it appears the curtain is continuous at the overlap.

Preferably the first overlap arm can be switched with the second overlap arm to allow the direction of the overlap to be changed.

According to a sixth aspect of preferred embodiments herein described there is provided a cord holder comprising: a body having magnetic coupling means for allowing the body of the cord holder to be moved between a first location and a second location, wherein when mounted within a curtain track having a curtain cord and positioned at the first location the body of the cord holder prevents the curtain cord from hanging downwardly out of the curtain track at the first location.

Preferably the cord holder includes a member for engaging part of the curtain track at the first location and preventing movement of the cord holder past the first location.

According to a seventh aspect of preferred embodiments herein described there is provided a curtain system comprising: a curtain track, a slide and a cord holder; both the slide and the cord holder having magnetic coupling means; when the slide and cord holder are positioned in the curtain track, the slide can be brought into magnetic engagement with the cord holder at a first location and push the cord holder to a second location from which the slide can be moved back to the first location with the curtain track allowing movement of the slide back past the first location and restraining movement of the cord holder to cause the cord holder to remain at the first location to prevent a cord within the curtain track from hanging downwardly out of the curtain track at the first location.

According to an eighth aspect of preferred embodiments herein described there is provided a curtain slide for a curtain track comprising: a body having an upper portion and a lower portion, the upper portion having a recess for receiving an overlap arm; the lower portion comprising a base portion adapted to be held in the curtain track, the base portion including a first end having a mount.

Preferably the mount of the first end of the base portion includes a hole that is adapted to receive a screw and which, when the curtain slide is held in the curtain track, faces along the curtain track.

Preferably the base portion includes a second end, opposite to the first end, the second end having a mount, the mount including a hole that is adapted to receive a screw and which, when the curtain slide is held in the curtain track, faces along the curtain track in a direction opposite to the hole of the mount of the first end of the base portion.

According to a ninth aspect of preferred embodiments herein described there is provided a mitre join component comprising a first portion for being inserted into a first curtain track and a second portion for being inserted into a second curtain track, the first portion and the second portion being angularly separated such the first track and second track form a mitre join, each of the portions including a mount such that a curtain can be fixed to either side of the mitre join.

Preferably the first portion and the second portion each include a mount for receiving a screw through the opening of each curtain track to fix the mitre join in position.

As will be discussed there are considered to be a number of preferred arrangements of the present invention that provide several advantages including:
(i) systems that provide the ability to replicate the gentle continuous smooth u-shaped folds of a commercial Ripplefold curtain system;
(ii) systems that allow for a curtain to be hung from a curtain track in any one of a plurality different configurations, each configuration associated with a different fabric width.
(iii) systems that provide the ability to use less fabric as a result of different spacings as well as not requiring as much fabric to form an adequate ‘full’ looking fold by virtue of the elastic resilience provided;
(iv) systems that provide the ability to provide a fuller or minimalist look to meet the requirements of the end user;
(v) systems that reduce the labour in manufacture as well reduce fabric costs;
(vi) systems that allow for ready installation and removal of the curtain for installation, cleaning and other purposes;
(vii) systems that provide multipurpose runners that can be used in a variety of circumstances providing benefits to installers;
(viii) systems that provide rounded curtains with the appearance of a rearward fold at the overlap to give the impression that the curtain is continuous;
(ix) systems that provide advantageous mitre join arrangements; and
(x) systems that provide a cord holder that remains at a desired location to prevent the a curtain cord from hanging downwardly out of the curtain track at that position.

It is to be recognised that other aspects, preferred forms and advantages of the present invention will be apparent from the specification including the detailed description, drawings and claims.

### BRIEF DESCRIPTION OF DRAWINGS

In order to facilitate a better understanding of the present invention, several preferred embodiments will now be described with reference to the accompanying drawings, in which:

FIG. 1 provides several views of an existing commercial curtain system;

FIG. 2 provides several views of a curtain system according to a first preferred embodiment of the present invention;

FIGS. 3 to 6 provide perspective views illustrating components of the curtain system shown in FIG. 2;

FIG. 7 provides schematic views showing two different curtains hung using the curtain system shown in FIG. 2;

FIG. 8 provides perspective views illustrating a component of the curtain system shown in FIG. 2;

FIG. 9 provides a perspective view of existing Australian Registered Design AU319542;

FIGS. 10 to 11 provides several views of a curtain overlap system according to another preferred embodiment of the present invention;

FIGS. 12 to 14 provides several views of a cord holder system according to yet another preferred embodiment of the present invention; and

FIG. 15 provides several views of a mitre join component according to a further preferred embodiment of the present invention.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

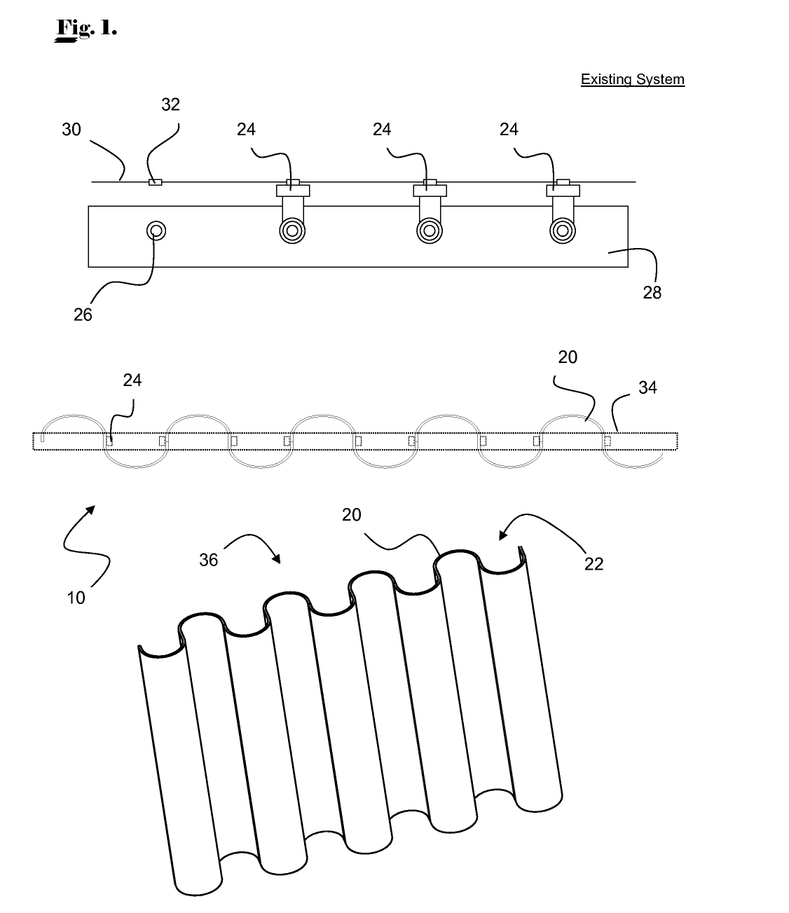

FIG. 1 illustrates a commercial hand drawn curtain system 10 know as the Forest Drapery RDS Ripplefold Drapery System®. The Ripplefold curtain system 10 is provided as one of a suite of commercial drapery systems produced by Forest Drapery. The suite includes the Forest Drapery KS Klick System®, Forest Drapery CKS Corded Klick System®, Forest Drapery DS Design System®, and the Forest Drapery CS Contract System®. Each of these systems is a hand drawn system that is engineered to support fabric up to about 4 to 8 kg or more per meter. The Ripplefold curtain system 10 is suited to commercial use in hotels, motels, restaurants and hospitals.

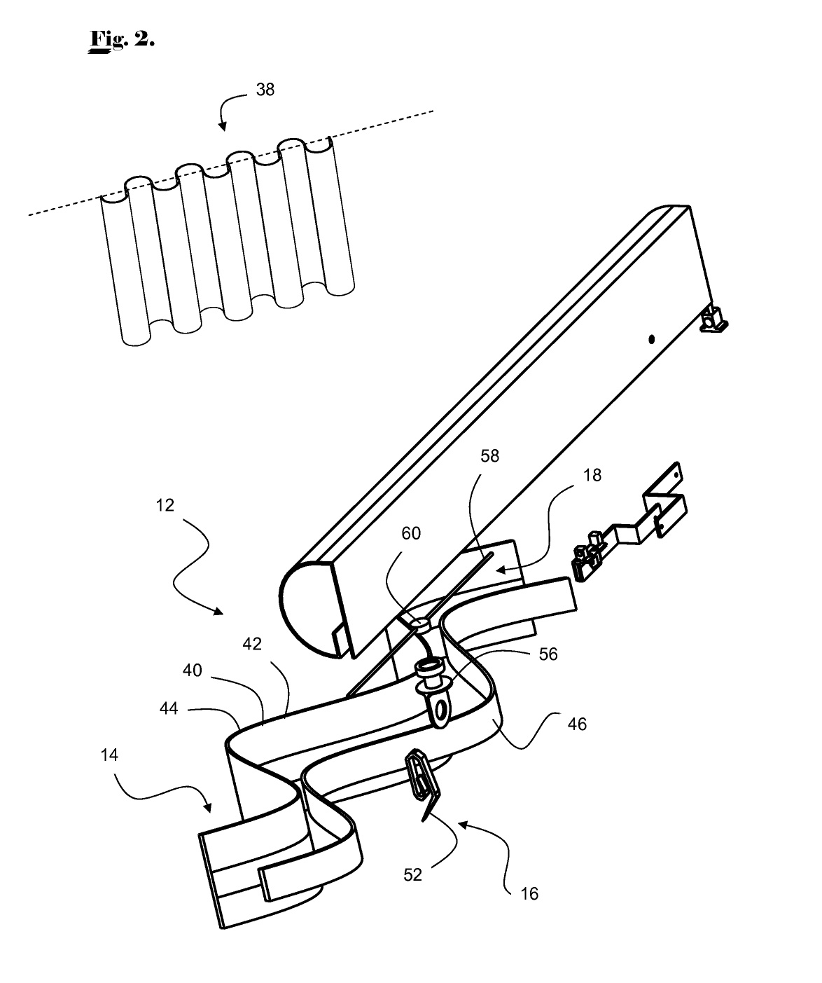

Referring to FIG. 2, there is shown a curtain system 12 according to a first preferred embodiment of the present invention. The curtain system 12 provides a domestic hand drawn curtain system that is suited to domestic use and which has several advantages over the commercial Ripplefold curtain system 10 illustrated in FIG. 1. One of these advantages is that the curtain system 12 is able to replicate the gentle continuous smooth folds of the Ripplefold curtain system 10 in an effective and advantageous manner. Another advantage is that the curtain system 12 uses curtain tape that is cut to fit the fabric and by the construction of the system allows the quantity of fabric to be varied. Among other things, this is considered to be particularly useful in terms of reducing the overal curtain cost. Furthermore the curtain system 12 can be used to provide a fuller or minimalist look to meet the requirements of the end user.

As shown in FIG. 1 the curtain system 12 includes curtain tape 14, hook elements 16, and a multipurpose runner cord 18. Each of these components is considered to be advantageous in their own right. Nonetheless the components are used in the curtain system 12 to provide several advantages, some of which are listed above and others of which are described below.

Returning to FIG. 1, the Ripplefold curtain system 10 is able to hang a curtain 20 such that the curtain 20 hangs downwardly to form a number of continuous and gently repeating U-shaped folds 22. The Ripplefold curtain system 10 includes a plurality of snap carriers 24 adapted to engage a plurality of snap rivets 26, provided on a nylon curtain tape 28. In the Ripplefold curtain system 12, the carriers 24 are attached to a nylon cord 30 using of a plurality of mounts 32. The mounts 32 have an enlarged rim which advantageously allows the snap carriers 24 to rotate about their longitudinal axes to accommodate movement of the curtain 20, when the curtain 20 is opened and closed. The snap carriers 24 are fed through a curtain track 34 and direct the curtain tape 28 to provide the overall continuous and gentle drapery fold 36.

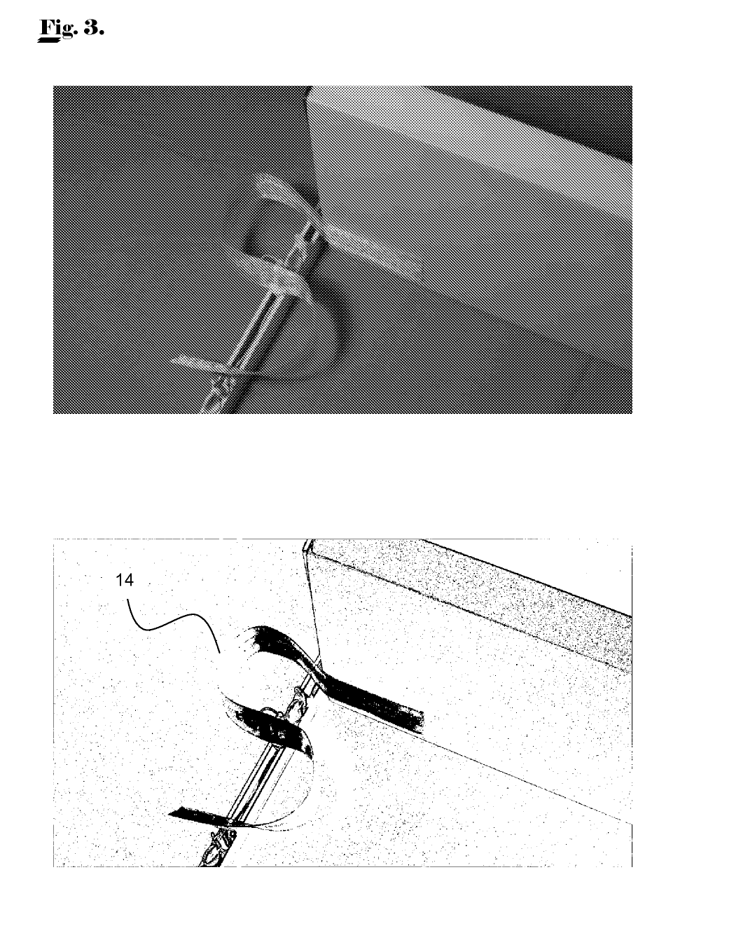

In the curtain system 12, the curtain tape 14 is advantageously elastically resilient as shown in FIG. 3 to provide a spring effect presently not considered to be provided by the Ripplefold curtain system 10. This is considered to be advantageous as the folds of the curtain system 12 are considered to be provided with improved fullness and a gentle and continuous fold.

In the present embodiment, the curtain tape 14 is made of clear elastically resilient nylon, where the tape will resist bending to uncoil when bent into a circle of even say 10 cm in diameter. Comparatively, in the Ripplefold system 10, the nylon tape 28 is threaded and not is elastically resilient to provide a similar spring effect. The tape 28 certainly does not bend when formed in a 10 cm circle.

The curtain tape 14, of the present embodiment, comprises an integrally formed elastically resilient nylon mesh. The curtain tape 14 does not use snap carriers 24 or rivets 26 and has an advantageous construction described in detail below. Using the curtain tape 14 it is possible to provide an advantageous drapery fold 38 shown in FIG. 2.

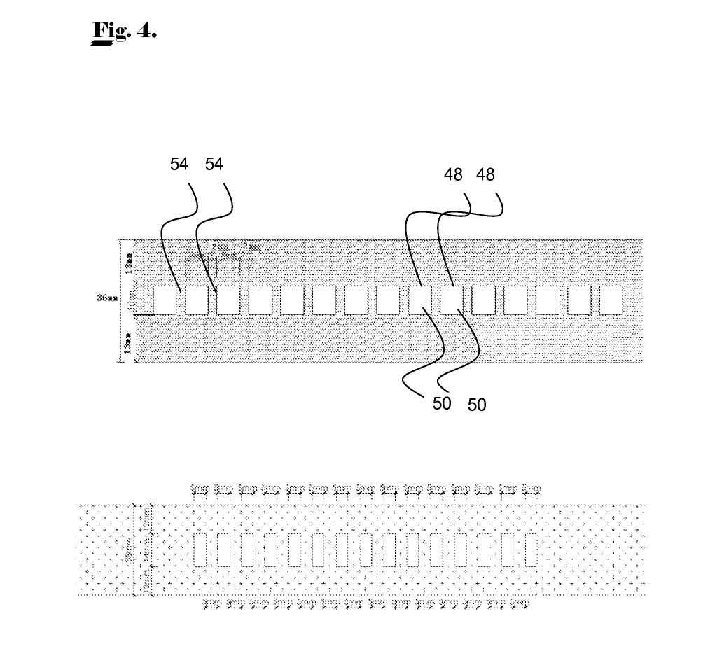

The curtain tape 14 comprises a body 40 having a first portion 42 for being fixed to a curtain using glue, thread or otherwise. The curtain tape 14 comprises a first length 44 of nylon mesh material and a second length 46 of nylon mesh material as shown in FIG. 1. The second length 46 of nylon mesh material is narrower than the first length 44 of nylon mesh material. Furthermore, the second length 46 of nylon mesh material is physically welded to the first length 44 to advantageously provide a plurality of carrier mounts 48 in the form of mesh loop portions 50, more clearly illustrated in FIG. 4. The mesh loop portions 50 advantageously allow for mounting a plurality of hook elements 52 that grip the loop portions 50.

In the present embodiment, the loop portions 50 are spaced along the length of the body 40 of the curtain tape 14 at intervals of 1 cm to allow for the curtain to be hung from the hook elements 52 in any one of a number of different configurations, each corresponding with a different spacing. The spacing is considered to be particularly advantageous because it allows a window to be draped by curtains of different width while providing a relatively firm, continuous and gentle U shaped-drapery fold 38.

As shown in FIG. 4, the second length 46 is welded to the first length 44 by a plurality of relatively narrow welds 54. In the present embodiment the welds 54 have a width of 2 mm and extend across the full width of the second length 46. Different embodiments may have a spacing of say 1.5 cm or more or even less than 1 cm. Importantly the curtain system 10 allows a window to be draped by curtains of different width without an unsightly number of folds while still providing the continuous and gentle U shaped-drapery fold 38. The curtains are each associated with a different spacing whereby they are hung in different configurations each associated with a different curtain width.

In the curtain system 12, this is achieved by threading the hook elements 52 through the loop portions 50 at different intervals along the curtain tape 14. To hold the hook elements 52 and support the curtain, the multipurpose runner cord 18 includes a plurality of runners 56 slidably mounted within the track. In the embodiment, the runners 56 are releasably attached to a flexible runner cord 58 having a plurality of cylindrical mounts 60 spaced therealong at regular intervals.

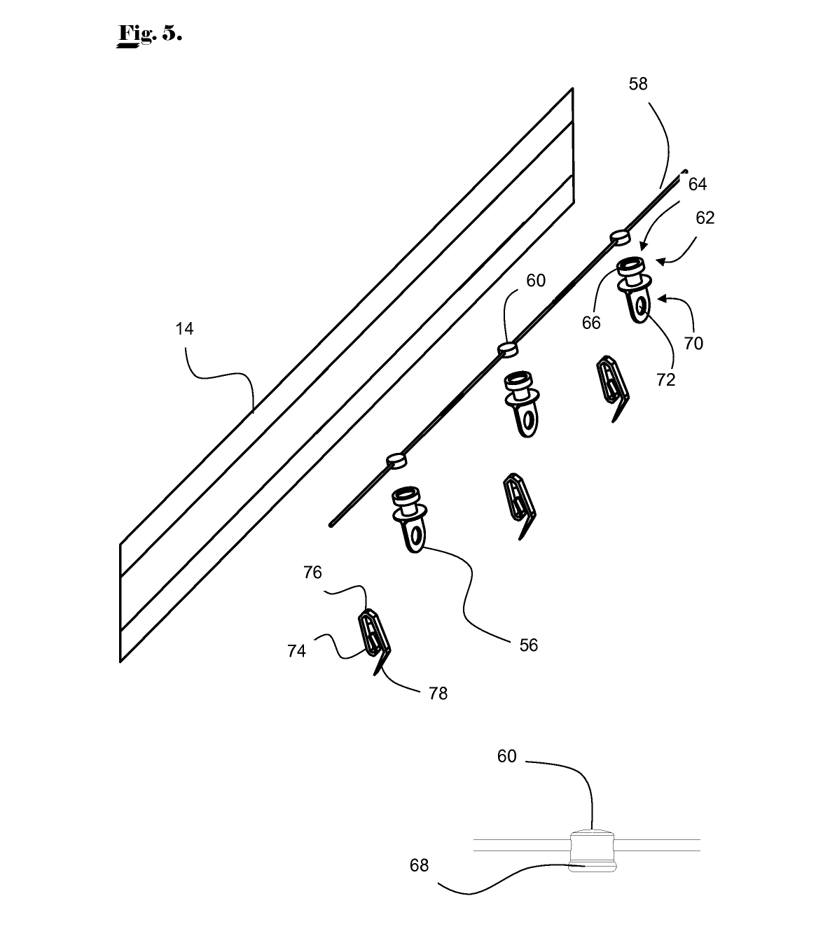

As shown in FIG. 5, each runner 56 has a lower portion 62 with a corresponding mount 64 in the form of a recess 66 where each recess 66 is adapted to receive one of the cylindrical mounts 60. The cylindrical mounts 60 are clicked into place by the recesses 66 engaging an enlarged lower rim 68 of each mount 60. Once clicked into place, each of the runners 56 can rotate relative to the flexible runner cord 58 about the longitudinal axis of the runner by virtue of the cylindrical engagement.

Each runner 56 further includes an upper portion 70 providing an opening 72 sized to receive a corresponding hook element 52. In addition to the runners 56 being rotatable about their longitudinal axes, each of the runners 56 can be removed from the flexible runner cord 58 and be used in the track of a conventional curtain track with a mouth of about 6 mm wide. In this embodiment, the upper portion 70 has a width of about 0.3 mm so as to be able to receive a conventional Rufflette R7 sized hook, if required.

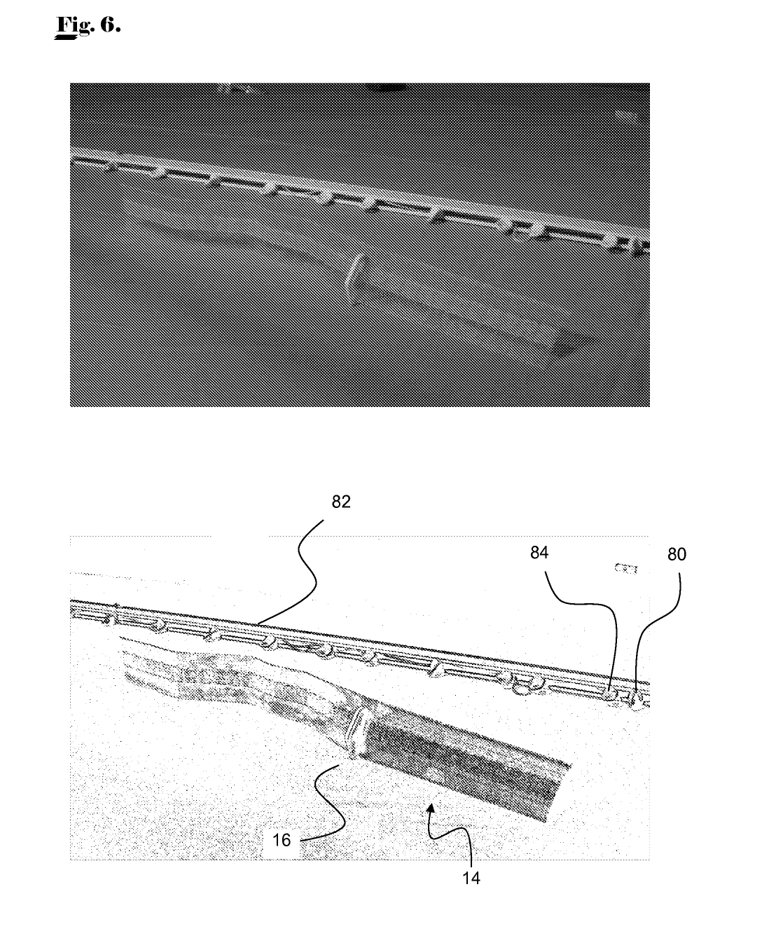

The hook elements 52 comprise plastic hooks each having a first portion 74 for holding a respective one of the loop portions 50, as illustrated in FIG. 5, and a second portion 76 for engaging a respective runner 56. Each hook element 52 includes a portion 78 that bends back towards the curtain tape 14 as shown in FIG. 6.

As with the Ripplefold curtain system 10, the ability of the runners 56 to rotate is advantageous as it allows for smooth accommodating motion when the curtain attached to the curtain tape 14 is opened and closed. As would be apparent, the upper portions 70 of the runners 56 move from a position 80 more perpendicular to the curtain track 82 to a position 84 more parallel with the curtain track 82, as the curtain is closed.

As indicated above, the curtain system 12 is considered to be advantageous for the reasons that the system allows a window to be draped by curtains of different width while still providing the continuous and gentle repeating U-shaped drapery fold 38. This advantage allows curtains of a width of about 4m to be used on a curtain track ranging from say 1.5 to 3m where with the Ripplefold curtain system 10 would not.

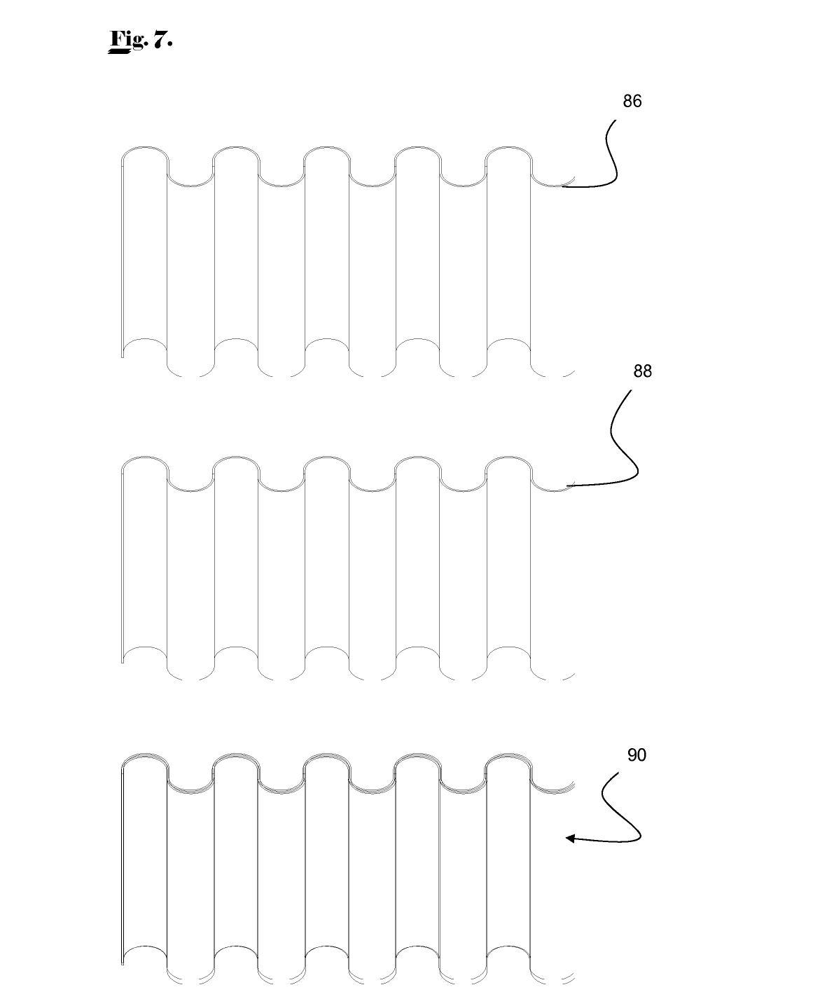

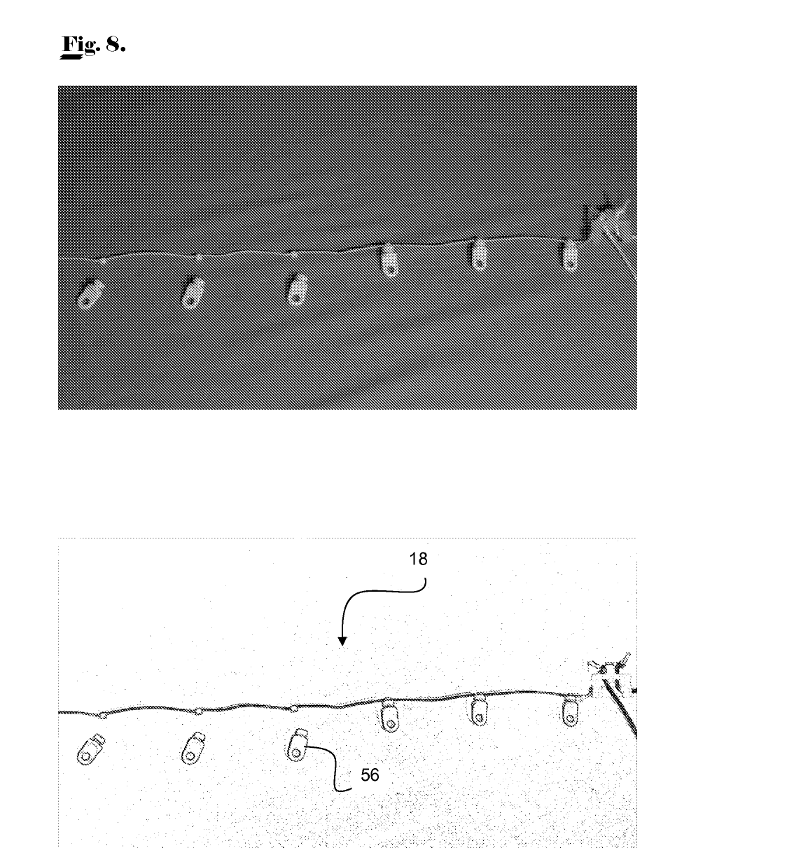

FIG. 7 illustrates this advantage by comparing a first curtain 86 and a second curtain 88. The first curtain 86 is advantageously provided in a first configuration with the curtain tape 14 and the hook elements 16 being spaced at 9 cm intervals. A multipurpose runner cord 18 is provided with a 6 cm spacing interval.

The second curtain 88 is provided with the curtain tape 14 and the hook elements 16 spaced at 11 cm intervals. With 10 folds this equates to the second curtain 88 being about 20 cm wider than the first curtain 86, when flat. With say 20 folds this provides an additional length of 40 cm.

Using the curtain system 12 is possible to accommodate this additional length within the folds rather than having to have more folds. FIG. 6 provides an overlayed schematic view 90 of the first curtain 86 and the second curtain 88. As shown in the overlayed schematic view 90, the extra length is accommodated within the folds themselves. This is considered to be advantageous.

The ability to accommodate different widths of curtain without unsightly bunching due to different numbers of folds is also advantageous because it allows for substantial cost savings in the manufacture of the curtains themselves.

The hook elements 52 can simply be placed further or closer together to accommodate a particular curtain width. This is considered to be unlike any other hand drawn system for drapes, whether or not the system is a commercial or domestic system. Furthermore, with the present embodiment it is considered that less fabric can used as the spaces do not require as much fabric to form an adequate full looking fold, due to the elastic resilience of the curtain tape 14.

The curtain system 12 is considered to, in turn, reduce labour in manufacture as well as reduce fabric costs as described. It is considered that there is presently present no other drapery system forming similar folds where the fabric does not have to be cut to fit the tape. In the present embodiment, the curtain tape 14 is cut to fit the fabric making the fabric quantity very flexible.

Furthermore, the curtain system 12 is also considered to be advantageous as it allows for the curtains to be readily installed by threading the portions 78 of the hook elements 52 though the loop portions 50 and then hanging the hook elements 52 on the runners 56 in the curtain track 82. Of course the further advantage of the curtain system 12 is that the runners 56 can be removed from the flexible runner cord 58 and be used in the track of a conventional curtain track.

In the curtain industry this is considered to be particularly useful because it means that different types of runners do not need to be ordered from manufactures. Also during installation, professional installers require only one form of runner for a multitude of operations. With the Ripplefold curtain system 10 the snap carriers 24 must be snapped onto the snap rivets 26 with the curtain being held in position. With a heavy curtain and with only one installer this can be particularly difficult. Furthermore the snap rivets 26 must be riveted through the nylon tape 28 before the tape is fixed to the curtain. Both operations are considered to be relatively difficult and time consuming.

In summary, the curtain system 12 is considered to be able to replicate the gentle continuous folding provided by the Ripplefold curtain system 10, in an advantageous manner that allows for ready installation, removal and is cost effective so as to allow the system to be readily used in domestic applications. The stiffness of the curtain tape 14, as described above, allows for the spring effect to be achieved and provide firmness in the fold. The 8 mm pockets with 2 mm spaces between them provides a high degree of accuracy in allowing the placement of hooks such that the hooks can be relatively evenly spaced and allows for relatively soft folds to form in the spaces therebetween.

In both systems the curtain tape 14 allows for accurate spacing, distributes the weight of heavy drapes known to otherwise provide a high amount of drag especially with a pinch pleat system.

An additional advantage of the curtain system 10 is that the system allows an end user to vary the relative sizes of the back and front folds which is clearly not achievable with the Ripplefold curtain system 10. Differently sized mounting bracket can be used ensure that the curtain does not touch the wall.

With the present embodiment the spacing of the mounts 60 along the multipurpose runner cord 18 is either 6.5 cm or 8 cm, although several different spacing are clearly also suitable. The Ripplefold system also comes in two different sizes, namely either 6 cm or 8 cm chain link spaces. The Ripplefold curtain system 10 has a standard separation of 11 cm between the rivets 26 that can be readily replicated by employing a spacing of about 11 cm between the hook elements 52 in the curtain system 12. Of course much larger and smaller spacing can also be used as a result of the advantageous flexibility of the curtain system 12.

The curtain system 12, while being able to replicate the Ripplefold curtain system 10, reduces costs at manufacture and provides flexibility in how much fabric must be used to reduce end user's costs. It is considered that no other presently available system does this in such an advantageous manner. With the tape being cut to fit the fabric, the curtain can also be made to look fuller or achieve a minimalist look depending on the requirements of the end user.

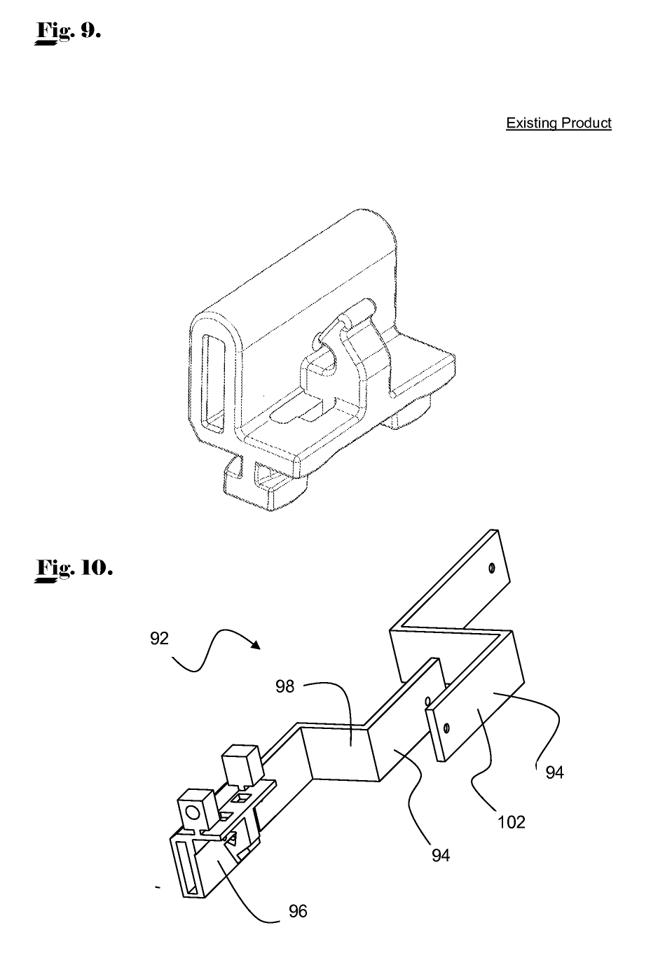

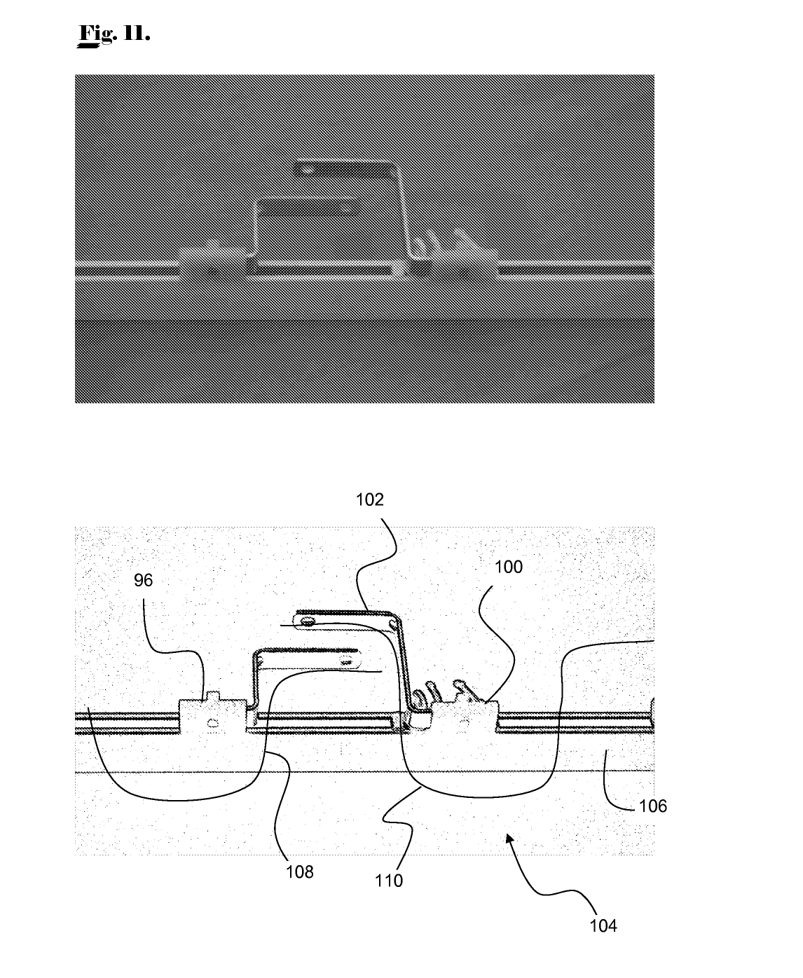

The inventor is the owner of Australian Registered Design AU319542 filed 31 Jan. 2008. This registered design comprises a slide illustrated in FIG. 9. The applicant has now realised that it is possible to use this slide runner to provide an advantageous curtain overlap system 92 illustrated in FIG. 1 and FIGS. 10-11. The overlap system 92 includes two reversible members 94 that operate to form what resembles a continuous rearward fold relative to the front face of the curtain track 82.

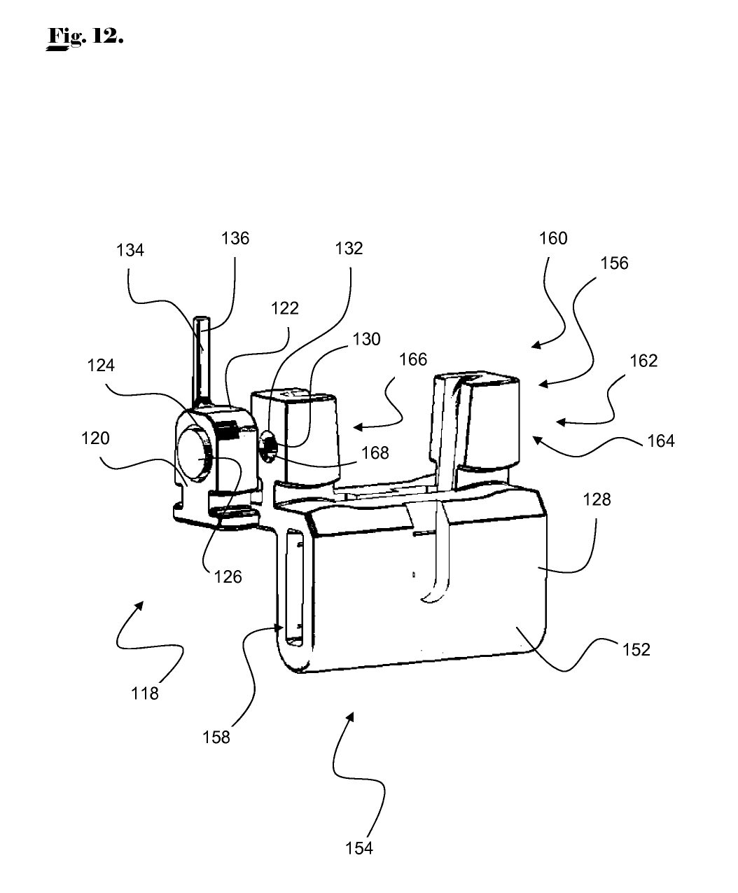

As shown in the FIG. 11, the curtain overlap system 92 includes a first slide component 96 having a first overlap arm 98, and a second slide component 100 having a second overlap arm 102. The slide components 96, 100 are adapted to present the overlap arms 98, 102 behind the midline of the curtain 104 (relative to the front face of the curtain track 106) such that is appears that the repeating portions of the curtain 104 are joined at the overlap. This illustrated by the portion 108 and the portion 110 of the curtain 104 in FIG. 11 where the track 106 serves to illustrate the midline of the curtain 104.

The ability to make it appear that the repeating rearward portions of the curtain are joined at the overlap is considered to be advantageous from an aesthetic viewpoint. In the Ripplefold curtain system 10 two forwardly facing U-shaped portions bear against each other in a manner that does not give the impression that the curtain is continuous. The curtain overlap system 92 advantageously provides portions that give the impression of a rearward fold.

Furthermore, in the overlap system 92 the first and second overlap arms 98, 102 are able to be switched. This means that the portion 110 of the curtain 104 can be presented in front of the portion 108. This is considered to advantageously prevent issues such as light peering through the curtain in say the early hours of the morning.

It is further considered that no other overlap system advantageously provides such an advantageous facility for providing the appearance of continuous curtain when the curtain has rounded folds. This is considered not only to make the curtain better to look at but to stop more light and more heat. Furthermore the design allows the components of the overlap system 92 to be used in other ways to accommodate one way tracks and one way mitered tracks.

The applicant has also modified the slide runner shown in FIG. 9 to provide a cord holder system 118 illustrated in FIGS. 12 to 14. The cord holder system 118 includes a cord holder 120 comprising: a body 122 having a recess 124 therein that is adapted to receive a magnetic coupling means 126. In the embodiment the magnetic coupling means 126 comprises a magnet that is received within the recess 124.

The cord holder system 118 further includes a modified slide 128 that is adapted to move the cord holder 120 between a first location and a second location such that when moved to the first location, the body 122 of the cord holder 120 prevents the slide cord from hanging downwardly out of the curtain track at the first location.

In the cord holder system 118, the slide 128 includes a magnetic coupling means 130 in the form of a metallic screw 132 extending into the base of the slide 128. The body 122 of the cord holder 120 includes an elongate member 134 for engaging part of the curtain track at the first location as will be described in detail below. As shown in FIG. 12, the member 134 comprises an upwardly extending arm 136 arranged on one side of the cord holder 120.

In the curtain system 12, the cord holder system 118 further includes a stop element 138 partly extending through a hole in the body of the curtain track 140. The stop element is provided in the form of a screw 142 positioned to engage the arm 136 of the cord holder 120 while still providing room for the slide cord 144 connected to the slide 128.

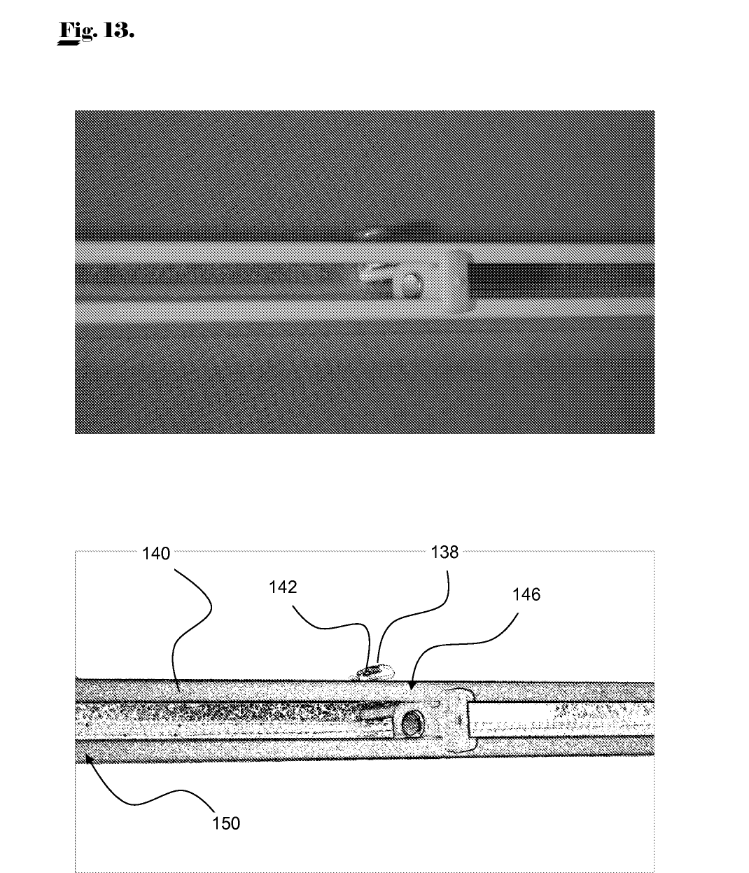

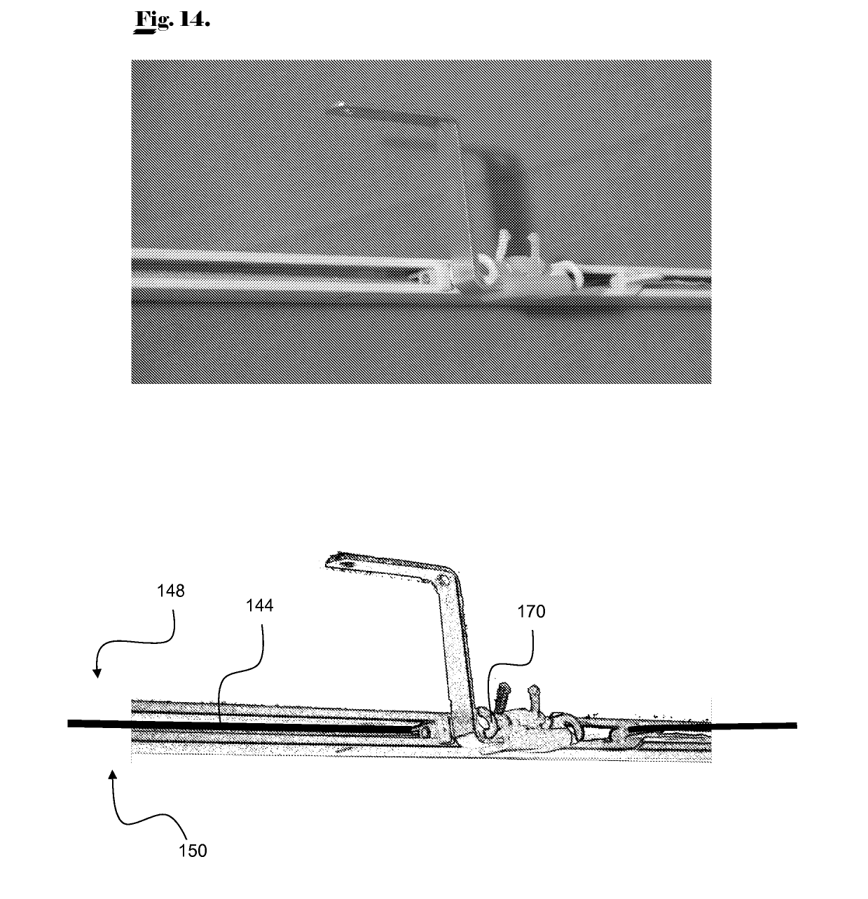

With the slide 128 and cord holder 120 positioned in the curtain track 140, the slide 128 can be brought into magnetic engagement with the cord holder 120 at the first location 146 shown in FIGS. 13 and 14. The slide cord 144 is pulled at an end 148 thereof to cause the slide holder 128 to push the cord holder 120 from the first location 146 to a second location 150. As such the cord holder 120 does not prevent the slide from moving but rather but moves therewith. With the cord holder 120 in the second location 150, the slide 128 can be returned to and moved past the first location 146 in the opposite direction. The stop element 138 of the curtain track does restrain movement of the slide 128 but does restrain movement of the cord holder 120 past the first location to cause the cord holder 120 to remain at the first location prevent the cord 144 of the curtain system from hanging downwardly out of the curtain track 140 at the first location 146. This is considered to be particularly useful.

The slide 128 shown in the FIG. 12 comprises a body 152 having an upper portion 154 and a lower portion 156. The upper portion 154 includes a recess 158 extending through the upper portion 154 for receiving an overlap arm. The lower portion 156 comprises a base portion 160 adapted to be held in the curtain track 140. The base portion 160 includes a first end 162 having a mount 164 than holds the magnetic coupling means 130 and a second end 166. In this embodiment the mount 164 includes a hole adapted to receive the screw 132. The second end 166 is identical to the first end 162 and includes a mount 168. Both the mount 164 and the mount 168 are provided as holes that are adapted to receive a screw. The mount 164 advantageously allows the cord of the multipurpose runner cord 18 to be attached thereto. The mount 164 provides for the magnetically coupling.

It is considered that the slide 128 provides an advantageous master slide in one piece of plastic with no assembly of parts required. As would be apparent the master slide is advantageously symmetrical allowing the slide to be used as a left or right hand slide suitable for u-shaped pleats as described as wells as inverted pleats. The base portion 160 that is held and concealed in the track is designed for several practical functions.

The first and second ends 162, 166 are provided as legs that are about 3 cm apart to provide a running edge size marginally bigger than normal runner that does not bind therefore allowing corners corded tracks to have smaller radii. The mounts 164, 168 face outwardly along the track such that the cord is usually always pulling in a direct line to pulleys at either end of the track.

As described a screw can be placed on either the left or right ends which can be used either for holding cord of chain link or to form a catcher for a magnetic carrier say on one way curtain tracks. The magnetic carrier in other embodiments may be built into the bottom of a conventional runner 170 shown in FIG. 14.

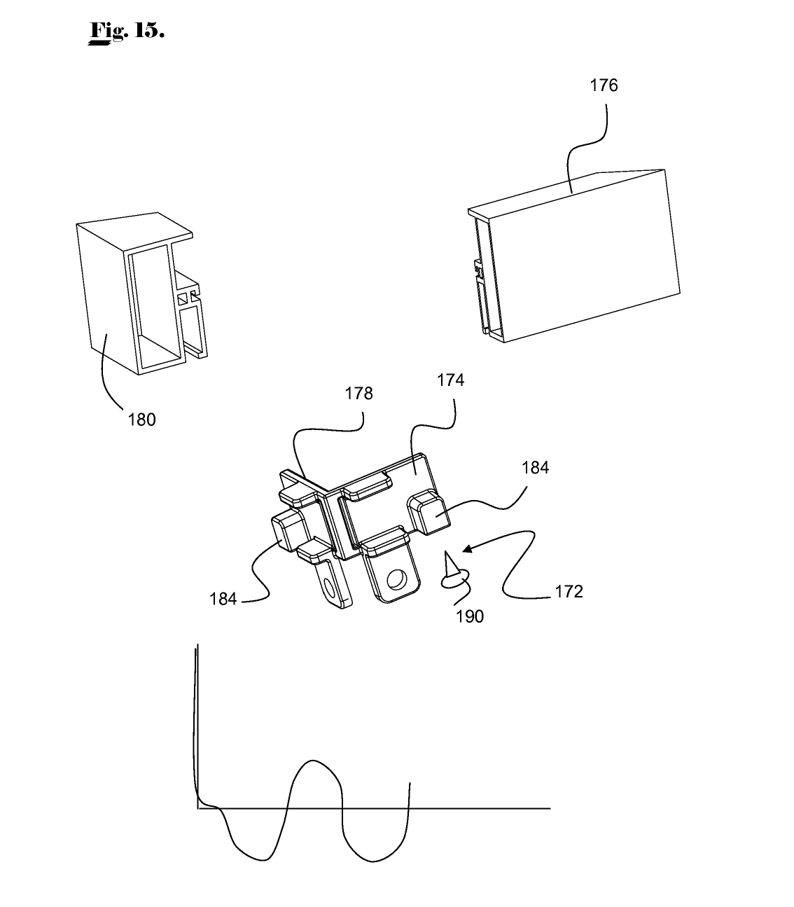

Referring lastly to FIG. 15, there is shown a mitre join component 172 for use in forming the track 82. The mitre join component 172 comprises a first portion 174 for being inserted into a first curtain track 176 and a second portion 178 for being inserted into a second curtain track 180. The first portion 174 and the second portion 178 are angularly separated by 90 degrees such the first track 176 and second track 180 form a 90 degree mitre join 182. Each of the first and second portions 174, 178 include a corresponding mount 184 allowing the curtain to be fixed at a location 186 and a location 188 either side of the mitre join. Each mount 184 is adapted to receive a screw through the opening of each curtain track to fix the mitre join in position.

It is considered that the mitre join component 172 advantageously allows the final hooks to face the required way and follow the contour of the track at the actual mitre. This includes U-Pleat, inverted pleats, pinch pleat and all gathering tapes that are used to manufacture curtains or drapes. The mitre join component 172 allows ready location of the mitre in position to allow for a neat finished end portion of the track to return to the wall.

As discussed above, the preferred embodiments provide a number of advantages including:
(i) systems that provide the ability to replicate the gentle continuous smooth u-shaped folds of a commercial Ripplefold curtain system;
(ii) systems that allow for a curtain to be hung from a curtain track in any one of a plurality different configurations, each configuration associated with a different fabric width.
(iii) systems that provide the ability to use less fabric as a result of different spacings as well as not requiring as much fabric to form an adequate ‘full’ looking fold by virtue of the elastic resilience provided;
(iv) systems that provide the ability to provide a fuller or minimalist look to meet the requirements of the end user;
(v) systems that reduce the labour in manufacture as well reduce fabric costs;
(vi) systems that allow for ready installation and removal of the curtain for installation, cleaning and other purposes;
(vii) systems that provide multipurpose runners that can be used in a variety of circumstances providing benefits to installers;
(viii) systems that provide rounded curtains with the appearance of a rearward fold at the overlap to give the impression that the curtain is continuous;
(ix) systems that provide advantageous mitre join arrangements; and
(x) systems that provide a cord holder that remains at a desired location to prevent the a curtain cord from hanging downwardly out of the curtain track at that position.

As would be apparent, various alterations and equivalent forms may be provided without departing from the spirit and scope of the present invention. This includes modifications within the scope of the appended claims along with all modifications, alternative constructions and equivalents.

In the present specification, the presence of particular features does not preclude the existence of further features. The words ‘comprising’, ‘including’ and ‘having’ are to be construed in an inclusive rather than an exclusive sense.

1. A curtain tape comprising: a body having a first portion for being fixed to a curtain; and a plurality of carrier mounts for mounting a plurality of carriers; wherein the carrier mounts are spaced along the length of the body at intervals less than 2 cm to allow for the curtain to be hung from the carrier mounts in any one of a plurality different configurations, each configuration being associated with a different curtain width.

2. A curtain tape as claimed in claim 1 wherein the body comprises elastically resilient material arranged to provide u-shaped folds in the curtain when the carriers mounts are brought together, with the carrier mounts comprising loop portions each adapted for receiving a hook shaped carrier.

3. A curtain tape as claimed in claim 2 wherein the loop portions are formed by fixing a piece of material in positions along the body of the curtain tape.

4. A curtain tape as claimed in claim 2 wherein the body of the curtain tape and the piece of material comprise weldable material, with the piece of material being fixed to the body of the curtain tape by welding the piece of material and body together at fixed locations spaced apart along the length of the body and the piece of material.

5. A curtain tape as claimed in claim 4 wherein the body of the curtain tape is less than 50 mm in width and the piece of material is less than 20 cm in width.

6. A curtain tape as claimed in claim 5 where the curtain tape is formed from elastically resilient nylon mesh material.

7. A runner for a curtain track including: a lower portion having a mount adapted to be mounted to one of several cord mounts spaced along a flexible runner cord in a manner such that, when mounted thereto, the runner is able to rotate relative to the flexible runner cord about the longitudinal axis of the runner; the runner having an upper portion sized to receive a curtain hook such that when attached to the flexible runner cord, the runner can be removed therefrom and be used in a conventional curtain track, the upper portion having a width less than 0.5 mm so as to be able to receive a conventional curtain hook.

8. A runner for a curtain track as claimed in claim 7 wherein the upper portion of the runner has a width less than 0.3 mm and is able to receive a conventional Rufflette R7 sized hook.

9. A runner system comprising: a flexible runner cord having a plurality of cord mounts spaced therealong; and a plurality of runners each having a lower portion with a mount adapted to couple to a respective one of the cord mounts of the flexible cord such that, when coupled, each runner can rotate relative to the flexible cord along the longitudinal axis of the runner, each runner having an upper portion sized to receive a curtain hook such that when attached to the flexible runner cord, the runner can be removed therefrom and be used in a conventional curtain track, the upper portion having a width less than 0.5 mm so as to be able to receive a conventional curtain hook.

10. A curtain overlap system for a curtain having repeating portions, the overlap system comprising: a first slide component having a first overlap arm; and a second slide component having a second overlap arm; wherein the slide components are adapted to present the overlap arms behind a midline of the curtain, rearwardly relative to the front face of the curtain track, such that it appears that the repeating portions of the curtain are joined at the overlap.

11. A curtain overlap system as claimed in claim 10 wherein the first overlap arm can be switched with the second overlap arm to allow the direction of the overlap to be changed.

12. A curtain overlap system comprising: a curtain hanging from a curtain track, wherein at an overlap of the curtain, a first side of the curtain is attached to an first overlap arm of a first slide component and a second side of the curtain is attached to a second overlap arm of a second slide component, the overlap arms extending behind a midline of the curtain relative to the front face of the curtain track such when the overlap arms are brought together it appears the curtain is continuous at the overlap.

13. A curtain overlap system as claimed in claim 12 wherein the first overlap arm can be switched with the second overlap arm to allow the direction of the overlap to be changed.

14. A cord holder comprising: a body having magnetic coupling means for allowing the body of the cord holder to be moved between a first location and a second location, wherein when mounted within a curtain track having a curtain cord and positioned at the first location the body of the cord holder prevents the curtain cord from hanging downwardly out of the curtain track at the first location.

15. A cord holder as claimed in claim 14 wherein the body of the cord holder includes a member for engaging part of the curtain track at the first location and preventing movement of the cord holder past the first location.

16. A curtain system comprising: a curtain track, a slide and a cord holder; both the slide and the cord holder having magnetic coupling means; when the slide and cord holder are positioned in the curtain track, the slide can be brought into magnetic engagement with the cord holder at a first location and push the cord holder to a second location from which the slide can be moved back to the first location with the curtain track allowing movement of the slide back past the first location and restraining movement of the cord holder to cause the cord holder to remain at the first location to prevent a cord within the curtain track from hanging downwardly out of the curtain track at the first location.

17. A curtain slide for a curtain track comprising: a body having an upper portion and a lower portion, the upper portion having a recess for receiving an overlap arm; the lower portion comprising a base portion adapted to be held in the curtain track, the base portion including a first end having a mount.

18. A curtain slide as claimed in claim 17 wherein the mount of the first end of the base portion includes a hole that is adapted to receive a screw and which, when the curtain slide is held in the curtain track, faces along the curtain track.

19. A curtain slide as claimed in claim 18 wherein the base portion includes a second end, opposite to the first end, the second end having a mount, the mount including a hole that is adapted to receive a screw and which, when the curtain slide is held in the curtain track, faces along the curtain track in a direction opposite to the hole of the mount of the first end of the base portion.

20. A mitre join component comprising a first portion for being inserted into a first curtain track and a second portion for being inserted into a second curtain track, the first portion and the second portion being angularly separated such the first track and second track form a mitre join, each of the portions including a mount such that a curtain can be fixed to either side of the mitre join.

21. A mitre join component as claimed in claim 20 wherein the first portion and the second portion each include a mount for receiving a screw through the opening of each curtain track to fix the mitre join in position.

22. (canceled)
